(19) United States
(12) Patent Application Publication
(10) Pub. No.: US 2007/0132315 A1
(43) Pub. Date: Jun. 14, 2007

(54) POWER SUPPLY SYSTEM

(75) Inventors: TING-KAI WANG, Tu-Cheng,Taipei Hsien (TW); ZHEN-HUA LI, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,543

(22) Filed: Aug. 18, 2006

(30) Foreign Application Priority Data
Nov. 25, 2005 (CN) 200510101795.6

(51) Int. Cl. H02J 1/10

(52) U.S. Cl. 307/18

(57) ABSTRACT

A power supply system for providing main power and standby power to peripheral electronic devices in a computer, comprises an input signal coming from a CPU of the computer; a driving device for receiving the input signal and generating a driving signal; a first power switch device connected with a first main power source and a first standby power source; and a second power switch device connected with a second main power source and a second standby power source. When the driving signal is transmitted into the first power switch device and the second power switch device, the first power switch device outputs the first main power source or the first standby power source in response to the driving signal to one of the peripheral electronic devices, and the second power switch device outputs the second main power source or the second standby power source in response to the driving signal to another one of the peripheral electronic devices.

### 1. FIELD OF THE INVENTION

The invention relates to a power supply system, and more particularly to a power supply system for selectively supplying main power and standby power.

### 2. DESCRIPTION OF RELATED ART

Typically, when a computer goes into a standby mode (known in the art as the “S3” mode), a working random access memory (RAM) of the computer is kept powered so as to preserve the data therein ready for a next power-up of the computer. The RAM is conventionally powered in the S3 condition by a specific power source, or a “standby power source”. Computers are generally provided with input/output (I/O) ports including a power supply conductor for powering peripheral devices connected to such ports. The same standby power source, which powers the RAM, is also conventionally used for providing power to these I/O ports. This is also typically the case for universal serial bus (USB) ports, which need to have power during the standby mode of the computer.

Referring to FIG. 1, a power supply circuit used for USB ports includes a first input 10, a first driving device 20, a first power switch device 30, a first main power source 31, a first standby power source 32, and a first output terminal 40.

The first input 10 is connected to a central processing unit (CPU) (not shown) and receives a first input signal from the CPU. The first driving device 20 includes resistors R11, R12, R13, transistors Q11 and Q12. The first input 10 is connected to a base of the transistor Q11 via the resistor R11. An emitter of the transistor Q11 is connected to ground and a collector of the transistor Q11 is connected to a base of the transistor Q12. The collector of the transistor Q11 is provided with a +5V voltage SB5 via the resistor R12. An emitter of the transistor Q12 is connected to ground and a collector of the transistor Q12 is provided with a +12V voltage via the resistor R13. A first driving signal is produced at the collector of the transistor Q12 after the first input signal is transmitted to the first driving device 20.

The first power switch device 30 includes a switch chip, resistors R14, R15 and a transistor Q13. The switch chip is a Si4501DY, which is a P-channel and N-channel assembled metal oxide semiconductor (MOS) transistor with 8 pins 1˜8. The first driving signal produced at the collector of the transistor Q12 is transmitted into pin 2 of the switch chip. A base of the transistor Q13 is connected to the base of the transistor Q12 via the resistor R14. An emitter of the transistor Q13 is connected to ground and a collector of the transistor Q13 is provided with a +5V voltage SB5 via the resistor R15. The collector of the transistor Q13 is connected to pin 4 of the switch chip. The first main power source 31 and the first standby power source 32 are connected to pin 1 and pin 3 of the switch chip respectively. Pins 5,6,7 and 8 of the switch chip are connected to the first output terminal 40. The first main power source 31 and the first standby power source 32 both are +5V provided by an ATX12 power source.

When a USB device is working normally the first input signal coming from the CPU is at a high level. At this time the transistor Q11 is turned on while the transistor Q12 and the transistor Q13 is turned off. The collector of the transistor Q12 and the collector of the transistor Q13 both are at high level. The first driving signal produced at the collector of the transistor Q12 is at high level too. Because the first driving signal is transmitted to the pin 2 and the collector of the transistor Q13 is connected to pin 4 of the switch chip, the pin 2 and pin 4 of the switch chip are at high level too. Accordingly the switch chip transmits the first main power source 31 to the first output terminal 40. When the USB device is working in a standby mode, the first input signal is at a low level. At this time the transistor Q11 is turned off and the transistor Q12 and the transistor Q13 is turned on. So the pin 2 and pin 4 of the switch chip are at low level, the switch chip transmits the first standby power source 32 to the first output terminal 40.

Referring to FIG. 2, a power supply circuit used for a memory includes a second input 50, a second driving device 60, a second power switch device 70, a second main power source 71, a second standby power source 72, and a second output terminal 80.

The second input 50 is connected to the CPU and receives a second input signal from the CPU. The second driving device 60 includes resistors R16, R17, R18, a transistor Q14 and a first N-channel metal oxide semiconductor (MOS) transistor M1. The second input 50 is connected to a base of the transistor Q14 via the resistor R16. A collector of the transistor Q14 is connected to a gate of the first N-channel MOS transistor M1. The collector of the transistor Q14 is provided with a +5V voltage SB5 via the resistor R17. A drain of the first N-channel MOS transistor M1 is provided with a +12V voltage via the resistor R18. A common terminal of a source of the first N-channel MOS transistor M1 and an emitter of the transistor Q14 is grounded. A second driving signal is produced at the drain of the first N-channel MOS transistor M1 after the second input signal is transmitted to the second driving device 60.

The second power switch device 70 includes a zener diode D11 and a second N-channel MOS transistor M2. The second main power source 71 is applied to a source of the second N-channel MOS transistor M2. The second standby power source 72 is applied to an anode of the zener diode D11. A common terminal of a drain of the second N-channel MOS transistor M2 and a cathode of the zener diode D11 is connected to the second output terminal 80. The drain of the first N-channel MOS transistor M1 is connected to a gate of the second N-channel MOS transistor M2, in this way the second driving signal is transmitted to the second power switch device 70.

When the memory is working normally the second input signal is at a high level. At this time the transistor Q14 is turned on and the first N-channel MOS transistor M1 is turned off, so the second driving signal is at a high level. The second driving signals is transmitted to the gate of the second N-channel MOS transistor M2, while the second N-channel MOS transistor M2 is on and the zener diode D11 is off. The second main power source 71 is applied to the second output terminal 80 via the second N-channel MOS transistor M2. Otherwise when the computer system is working in standby mode, the second input signal is at a low level. At this time the transistor Q14 is turned off and the first N-channel MOS transistor M1 is turned on, so the second driving signal is at a low level. The second driving signal is transmitted to the gate of the second N-channel MOS transistor M2, while the second N-channel MOS transistor M2 is off and the zener diode D11 is on. The second standby power source 72 is applied to the second output terminal 80 via the zener diode D11.

However, the first input 10 and the first driving device 20 of the power supply circuit used in USB ports have the same function as the second input 50 and the second driving device 60 of the power supply circuit used for the memory, and therefore it leads to a waste energy and an unsteady effect for the power supply system.

What is needed is a simplified power supply system for providing a main power source or a standby power source to the computer system.

### SUMMARY OF THE INVENTION

An exemplary power supply system for providing main power and standby power to peripheral electronic devices in a computer is provided. The power supply system comprises an input signal coming from a CPU of the computer; a driving device for receiving the input signal and generating a driving signal; a first power switch device connected with a first main power source and a first standby power source; and a second power switch device connected with a second main power source and a second standby power source. When the driving signal is transmitted into the first power switch device and the second power switch device, the first power switch device outputs the first main power source or the first standby power source in response to the driving signal to one of the peripheral electronic devices, and the second power switch device outputs the second main power source or the second standby power source in response to the driving signal to another one of the peripheral electronic devices.

Other advantages and novel features will become more apparent from the following detailed description when taken in conjunction with the accompanying drawing, in which:

### BRIEF DESCRIPTION OF THE DRAWINGS

FIG. 1 is a circuit diagram of a conventional power supply circuit used for USB ports;

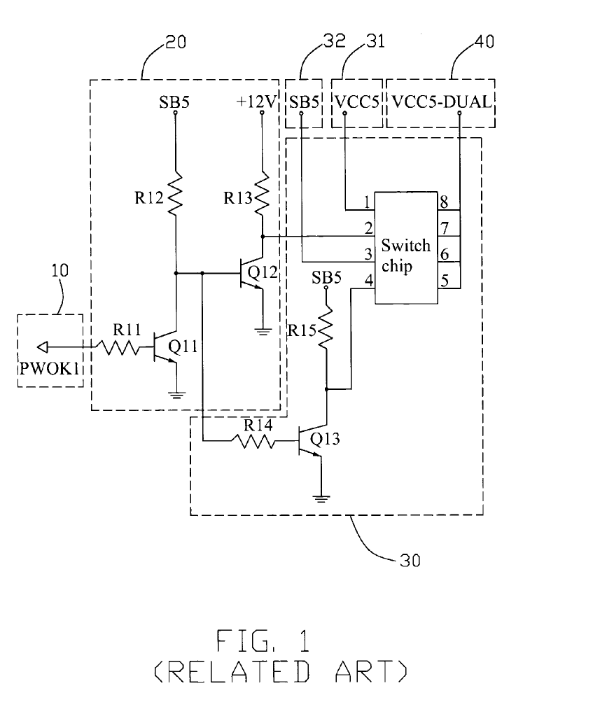

FIG. 2 is a circuit diagram of a conventional power supply circuit used for a memory; and

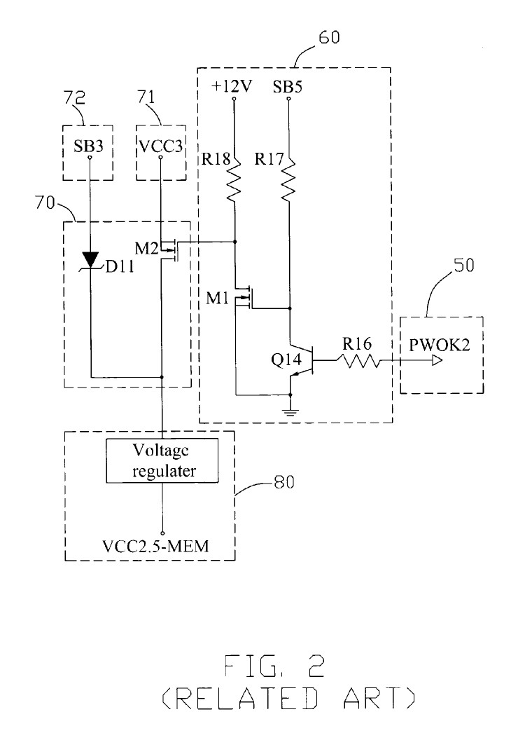

FIG. 3 is a circuit diagram of a power supply system used for a USB port and a memory in accordance with a preferred embodiment of the present invention.

### DETAILED DESCRIPTION OF THE INVENTION

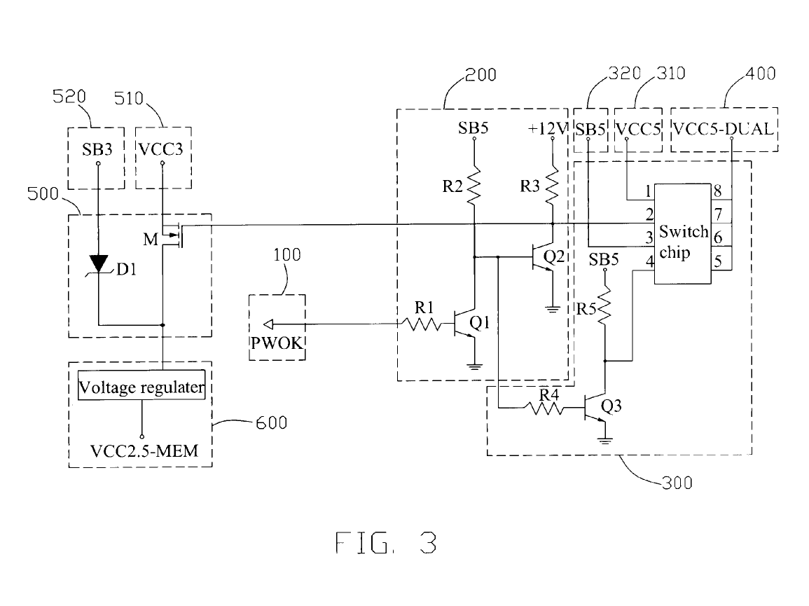

Referring to FIG. 3, a power supply system used for a USB port and a memory in accordance with a preferred embodiment of the present invention includes an input 100, a driving device 200, a first power switch device 300, a first main power source 310, a first standby power source 320, a first output terminal 400, a second power switch device 500, a second main power source 510, a second standby power source 520 and a second output terminal 600.

The input 100 is connected to a central processing unit (CPU) (not shown) and receives an input signal from the CPU. The driving device 200 includes a first resistor R1, a second resistor R2, a third resistor R3, a first transistor Q1, and a second transistor Q1. The input 100 is connected to a base of the first transistor Q1 via the first resistor R1. An emitter of the first transistor Q1 is connected to ground, and a collector of the first transistor Q1 is connected to a base of the second transistor Q2. The collector of the first transistor Q1 is provided with a +5V voltage SB5 via the second resistor R2. An emitter of the second transistor Q2 is connected to ground and a collector of the second transistor Q2 is provided with a +12V voltage via the third resistor R3. A driving signal is produced at the collector of the second transistor Q2 after the input 100 is transmitted to the driving device 200.

The first power switch device 300 includes a switch chip, a fourth resistor R4, a fifth resistor R5, and a third transistor Q3. The switch chip is a Si4501DY, which is a P-channel and N-channel assembled metal oxide semiconductor transistor (MOS) transistor in an 8-pin package. A base of the third transistor Q3 is connected to the base of the second transistor Q2 via the fourth resistor R4. An emitter of the third transistor Q3 is connected to ground and a collector of the third transistor Q3 is provided with a +5V voltage SB5 via the fifth resistor R5. The collector of the third transistor Q3 is connected to pin 4 of the switch chip. The first main power source 310 and the first standby power source 320 are connected to pin 1 and pin 3 of the switch chip respectively. Pins 5,6,7 and 8 of the switch chip are connected to the first output terminal 400 which is configured for elelctrically coupling to peripheral electronic devices of the computer, such as a USB device. The first main power source 310 and the first standby power source 320 are both provided +5V by an ATX12 power source. The driving signal produced at the collector of the second transistor Q2 is transmitted to pin 2 of the switch chip.

The second power switch device 500 includes a zener diode D1 and a N-channel MOS transistor M. The second main power source 510 is applied to a source of the N-channel MOS transistor M. The second standby power source 520 is applied to an anode of the zener diode D1. A common terminal of a drain of the N-channel MOS transistor M and a cathode of the zener diode D1 are connected to the second output terminal 600 which is configured for elelctrically coupling to peripheral electronic devices of the computer, such as a memory. The driving signal produced at the collector of the second transistor Q2 is transmitted to a gate of the N-channel MOS transistor M.

When the computer system (such as a USB device and the memory) is working normally, the input signal is at a high level. At this time, the first transistor Q1 is turned on while the second transistor Q2 and the third transistor Q3 are turned off. The collector of the second transistor Q2 and the collector of the third transistor Q3 are both at high level. The driving signal produced at the collector of the second transistor Q2 is at high level too. Because the driving signal and the collector of the third transistor Q3 are connected to the pin 2 and pin 4 of the switch chip, the pin 2 and pin 4 of the switch chip are at high level too. Accordingly the switch chip transmits the first main power source 310 to the first output terminal 400. Meanwhile the high level driving signals are transmitted to the gate of the N-channel MOS transistor M, while the N-channel MOS transistor M is on and the zener diode D1 is off. The second main power source 510 is applied to the second output terminal 600 via the N-channel MOS transistor M.

When the computer system (such as the USB device and the memory) is working in a standby mode, the input signal is at a low level, at this time the switch chip transmits the first standby power source 320 to the first output terminal 400 and the second power switch device 500 transmits the second standby power source 520 to the second output terminal 600.

Compared to the conventional power supply system the preferred embodiment of the present invention reduces the number of electronic elements required, which reduces the package size and cost of the circuit of the power supply system.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment.

What is claimed is:

1. A power supply system for providing main power and standby power to peripheral electronic devices of a computer, the power supply system comprising:
a driving device for receiving an input signal from a CPU of the computer and generating a driving signal;
a first power switch device connected with a first main power source and a first standby power source; and
a second power switch device connected with a second main power source and a second standby power source;
wherein the driving device is electrically coupled to the first and second power switch devices, when the driving signal is transmitted to the first power switch device and the second power switch device, the first power switch device outputs the first main power source or the first standby power source in response to the driving signal to one of the peripheral electronic devices, and the second power switch device outputs the second main power source or the second standby power source in response to the driving signal to another one of the peripheral electronic devices.

2. The power supply system as claimed in claim 1, wherein the driving device includes a first transistor and a second transistor, the first transistor comprises a control terminal for receiving the input signal, a grounded terminal, and a power terminal for receiving a first power, the second transistor comprises a control terminal connected to the power terminal of the first transistor, a grounded terminal, and a power terminal for receiving a second power, and the driving signal is produced at the power terminal of the second transistor.

3. The power supply system as claimed in claim 2, wherein the first power switch device includes a switch chip, a pin of the switch chip receives the driving signal, the first main power source and the first standby power source are connected to two other pins of the switch chip, output pins of the switch chip are combined as a first output terminal to output the first main power source or the first standby power source.

4. The power supply system as claimed in claim 3, wherein the switch chip is a Si4501DY.

5. The power supply system as claimed in claim 3, wherein the second power switch device includes a diode and a third transistor, the second main power source is applied to a power terminal of the third transistor, the second standby power source is applied to an anode of the diode, a common terminal of an output terminal of the third transistor and a cathode of the diode is connected to a second output terminal, the driving signal is transmitted into a control terminal of the third transistor.

6. A power supply system for providing main power and standby power to peripheral electronic devices of a computer, the power supply system comprising:
a driving device for receiving an input signal and generating a driving signal responsive to the input signal;
a first power switch device for receiving the driving signal;
a second power switch device for receiving the driving signal;
wherein the first power switch device is capable of selectively outputting a first main power source or a first standby power source in response to the driving signal to one of the peripheral electronic devices and the second power switch device is capable of selectively outputting a second main power source or a second standby power source in response to the driving signal to another one of the peripheral electronic devices.

7. The power supply system as claimed in claim 6, wherein when the input signal is at a high level the driving signal is at a low level, the first power switch device outputs the first main power source and the second power switch device outputs the second main power source.

8. The power supply system as claimed in claim 6, wherein when the input signal is at low level the driving signal is at a high level, the first power switch device outputs the first standby power source and the second power switch device outputs the second standby power source.

9. A computer comprising:
a CPU and a plurality of peripheral electronic devices;
a driving device for receiving an input signal from the CPU to generate a driving signal;
a first power switch device provided with a first main power source and a first standby power source; and
a second power switch device provided with a second main power source and a second standby power source; wherein
the driving device is electrically coupled to the first and second power switch devices for transmitting the driving signal to the first power switch device and the second power switch device, whereby the first power switch device selectively outputs one of the first main power source and the first standby power source in response to the driving signal to one of the peripheral electronic devices, and the second power switch device selectively outputs one of the second main power source and the second standby power source in response to the driving signal to another one of the peripheral electronic devices.

10. The computer as claimed in claim 9, wherein said one of the peripheral electronic devices is a Universal Serial Bus device.

11. The computer as claimed in claim 10, wherein said another one of the peripheral electronic devices is a memory.

12. The computer as claimed in claim 9, wherein when the input signal is at a high level the driving signal is at a low level, the first power switch device outputs the first main power source and the second power switch device outputs the second main power source.

13. The computer as claimed in claim 12, wherein when the input signal is at low level the driving signal is at a high level, the first power switch device outputs the first standby power source and the second power switch device outputs the second standby power source.

14. The computer as claimed in claim 13, wherein the driving device includes a first transistor and a second transistor, the first transistor comprises a control terminal for receiving the input signal, a grounded terminal, and a power terminal for receiving a first power, the second transistor comprises a control terminal connected to the power terminal of the first transistor, a grounded terminal, and a power terminal for receiving a second power, and the driving signal is produced at the power terminal of the second transistor.

15. The computer as claimed in claim 13, wherein the first power switch device includes a switch chip, a pin of the switch chip receives the driving signal, the first main power source and the first standby power source are connected to two other pins of the switch chip, output pins of the switch chip are combined as a first output terminal electrically coupled to said one of the peripheral electronic devices.

16. The computer as claimed in claim 13, wherein the second power switch device includes a diode and a third transistor, the second main power source is applied to a power terminal of the third transistor, the second standby power source is applied to an anode of the diode, a common terminal of an output terminal of the third transistor and a cathode of the diode is electrically coupled to said another one of the peripheral electronic devices, and the driving signal is transmitted into a control terminal of the third transistor.
